(19) United States
(12) Patent Application Publication
(10) Pub. No.: US 2019/0226361 A1
(43) Pub. Date: Jul. 25, 2019

(54) Turbocharger

(71) Applicant: MAN ENERGY SOLUTIONS SE, Augsburg (DE)

(72) Inventors: Urban SPATZ, Neusass (DE); Steffen Braun, Augsburg (DE); Daniel Albrecht, Augsburg (DE); Harald Denkel, Baar (DE); Stefan Weihard, Augsburg (DE); Bernd Haas, Neusass (DE); Johannes Niebuhr, Augsburg (DE)

(21) Appl. No.: 16/256,586

(22) Filed: Jan. 24, 2019

(30) Foreign Application Priority Data
Jan. 25, 2018 (DE) 102018101635.2

(51) Int. Cl. F01D 25/26; F02C 6/12; F01D 25/00

(52) U.S. Cl. CPC F01D 25/26; F02C 6/12; F01D 25/005; F05D 2300/615; F05D 2240/14; F05D 2300/211; F05D 2300/614; F05D 2220/40

(57) ABSTRACT

A turbocharger, with a turbine for expanding a first medium, a compressor for compressing a second medium utilising energy extracted in the turbine during the expansion of the first medium, a turbine housing of the turbine and a compressor housing of the compressor connected to a bearing housing arranged between the same, with a casing that radially and axially surrounds one or more of the turbine housing, the compressor housing, and the bearing housing at least in sections. At least one loose fibre of a defined length is introduced into a hollow space between the casing and a respective housing.

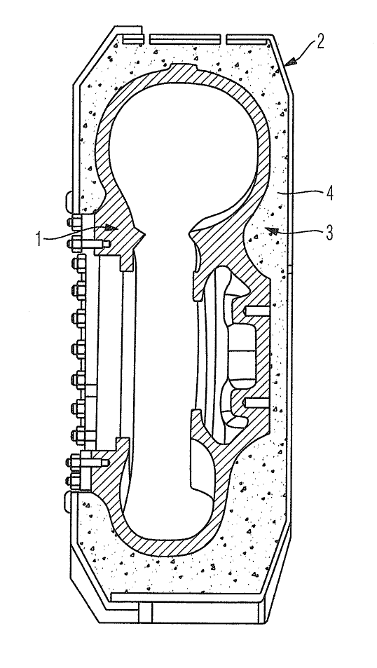

### BACKGROUND OF THE INVENTION

### 1. Field of the Invention

The invention relates to a casing of a turbocharger and to a turbocharger.

### 2. Description of the Related Art

The fundamental construction of a turbocharger is known to the person skilled in the art. A turbocharger comprises a turbine, in which a first medium is expanded, a compressor in which a second medium is compressed utilising energy extracted in the turbine during the expansion of the first medium, a turbine housing, and a turbine rotor. The compressor of the turbocharger comprises a compressor housing and a compressor rotor. Between the turbine housing and the compressor housing a bearing housing is positioned, wherein the bearing housing is connected to the turbine housing and to the compressor housing. In the bearing housing, a shaft is mounted, via which the turbine rotor is coupled to the compressor rotor.

During operation of a turbocharger there is a danger that a rotor, for example the turbine rotor or the compressor rotor of the turbocharger, breaks and fragments of the rotor strike through the relevant housing, i.e. the turbine housing or the compressor housing. There is then the danger that the fragments of the turbocharger enter the surroundings. In order to take into account this problem of the bursting of a rotor of the turbocharger, the respective housing, in turbochargers known from practice, is designed in such a manner that a failure of the respective housing need not be expected and even in the event of the breaking of the respective rotor, fragments of the same cannot strike through the respective housing. However, the weight of the turbocharger is increased because of this. So as not to unnecessarily increase the weight of the turbocharger and moreover protect turbochargers already employed in the field from fragments of a rotor striking through into the surroundings it is known to equip a turbocharger with a casing, which surrounds a turbine housing and/or a compressor housing, and/or a bearing housing of the turbocharger radially outside and axially outside at least in sections.

Such casings serve for providing a burst protection and serve for thermally insulating assemblies of the turbocharger.

There is a need for improving the effect of a casing that surrounds a housing of a turbocharger to be encased at least in sections.

### SUMMARY OF THE INVENTION

An object of one aspect of the invention is based on creating a new type of turbocharger.

According to one aspect of the invention, at least one loose fibre of a defined length is introduced into a hollow space between the casing and the respective housing of the turbocharger to be encased. A fibre that is loosely introduced in the hollow space between the casing of the turbocharger about the respective housing of the turbocharger to be encased can optimally adapt to the geometry of the housing to be encased and the casing and thus optimally fill out the hollow space. By way of this, a good sound absorption and a thermal insulation can be provided and a high energy absorption can be provided in the containment case during the bursting of an impeller.

Preferentially, the fibre or the respective fibre is formed as glass fibre or as silicate fibre. Glass fibres are suitable in particular when the housing to be encased is heated to approximately 600° C. Silicate fibres are suitable in particular when the housing to be encased is heated to approximately 1,000° C.

Preferentially, the fibre or the respective fibre has a length of at least 100 m, preferably of at least 200 m, particularly preferably of at least 500 m, most preferably of at least 1,000 m. The or the respective fibre is preferentially a continuous fibre or a filament. Such long fibres allow optimally filling out the hollow space between the housing to be encased and the casing. Most preferably, the or each fibre is embodied as continuous fibre or as filament and has a length of at least 1,000 m.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The FIGURE is a schematic cross section through a turbocharger in a region of a housing of the turbocharger and of a casing of the housing.

### DETAILED DESCRIPTION OF THE PRESENTLY PREFERRED EMBODIMENTS

The person skilled in the art is familiar with the fundamental construction of a turbocharger. Accordingly, a turbocharger comprises a turbine for expanding a first medium, in particular for expanding exhaust gas, and a compressor for compressing a second medium, in particular for compressing charge air, namely utilising the energy extracted in the turbine during the expansion of the first medium.

The turbine comprises a turbine rotor and a turbine housing. The compressor comprises a compressor rotor and a compressor housing. The turbine rotor and the compressor rotor are coupled via a shaft mounted in a bearing housing of the turbocharger, wherein the bearing housing is connected to both the turbine housing and the compressor housing.

In particular when during operation the turbine rotor or the compressor rotor breaks, fragments of the same can strike through the respective housing, i.e. the turbine housing or the compressor housing, and enter the surroundings. This has to be avoided for the purpose of which it is known to equip a turbocharger with a casing that surrounds the turbine housing and/or the compressor housing and/or the bearing housing of the turbocharger.

Preferentially, a separate casing is employed in each case in the region of the turbine housing and of the compressor housing, which surrounds the respective housing of the turbocharger to be encased radially outside and axially outside at least in sections.

Such casings not only serve for providing a burst protection. Such casings can also serve for thermal insulation and sound insulation of assemblies of the turbocharger.

The FIGURE shows a schematic cross section through a turbocharger in a region of a turbine housing 1 and of a casing 2 surrounding the turbine housing 1 on the outside at least in sections. The construction of the casing 2 is irrelevant to the present invention. Between the housing 1 to be encased, here the turbine inflow housing of a turbine of a turbocharger, and the casing 2, a hollow space 3 is formed. According to one aspect of the invention, at least one loose fibre 4 of a defined length is introduced into this hollow space 3.

The or the respective fibre introduced into the hollow space 3 is preferentially formed as glass fibre or silicate fibre.

The or the respective fibre 4 introduced into the hollow space 3 preferentially has a length of at least 100 m, preferably a length of at least 200 m, particularly preferably a length of at least 500 m, most preferably a length of at least 1,000 m. A single fibre or multiple such fibres 4 can be introduced into the hollow space 3 between the housing 1 to be encased and the casing 2 of the turbocharger.

Most preferably, the or each fibre 4 is formed as a continuous fibre or filament with a length of at least 1,000 m.

The respective fibre 4 is preferentially blown into the hollow space 3.

Such a fibre 4 that is loosely introduced into the hollow space 3 can optimally adapt to or hug the geometry of the housing 1 to be encased and of the casing 2. A high sound absorption and in the containment case a high energy absorption can be provided. The thermal insulation can also be improved.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger, comprising
a turbine for expanding a first medium;
a compressor for compressing a second medium utilizing energy extracted in the turbine during expansion of the first medium;
a turbine housing of the turbine;
a compressor housing of the compressor
a bearing housing arranged between and connected to the compressor housing and the turbine housing;
a casing which radially outside and axially outside surrounds, at least in sections, one or more of the turbine housing, the compressor housing, and the bearing housing; and wherein
at least one loose fibre of a defined length is introduced into a hollow space between the casing and a respective housing to be encased.

2. The turbocharger according to claim 1, wherein the at least one loose fibre is a glass fibre.

3. The turbocharger according to claim 1, wherein the at least one loose fibre is a silicate fibre.

4. The turbocharger according to claim 1, wherein the at least one loose fibre has a length of at least 100 m.

5. The turbocharger according to claim 1, wherein the at least one loose fibre has a length of at least 200 m.

6. The turbocharger according to claim 1, wherein the at least one loose fibre has a length of at least 500 m.

7. The turbocharger according to claim 1, wherein the at least one loose fibre has a length of at least 1,000 m.

8. The turbocharger according to claim 1, wherein the at least one loose fibre is a continuous fibre or a filament.

9. The turbocharger according to claim 1, wherein a single loose fibre is introduced into the hollow space between the casing and the respective housing to be encased.

10. The turbocharger according to claim 1, wherein multiple loose fibres are introduced into the hollow space between the casing and the respective housing to be encased.

11. The turbocharger according to claim 1, wherein the at least one loose fibre is a single glass fibre having a length of at least 200 m.

12. The turbocharger according to claim 1, wherein the at least one loose fibre is a single silicate fibre having a length of at least 200 m.

13. The turbocharger according to claim 1, wherein the at least one loose fibre is multiple loose fibres having a length of at least 200 m.

14. The turbocharger according to claim 1, wherein the at least one loose fibre is multiple loose fibres having a length of at least 200 m.
